(19) United States
(12) Patent Application Publication
(10) Pub. No.: US 2016/0179137 A1
(43) Pub. Date: Jun. 23, 2016

(54) DUAL ACCELEROMETER DETECTOR FOR CLAMSHELL DEVICES

(71) Applicants: STMicroelectronics S.r.l., Agrate Brianza (IT); STMicroelectronics, Inc., Coppell, TX (US)

(72) Inventors: Paolo Bendiscioli, Pavia (IT); William R. Raasch, Longmont, CO (US); Wen Lin, Longmont, CO (US); Alberto Ressia, Viguzzolo (IT)

(73) Assignees: STMicroelectronics S.r.l., Agrate Brianza (IT); STMicroelectronics, Inc., Coppell, TX (US)

(21) Appl. No.: 15/057,420

(22) Filed: Mar. 1, 2016

Related U.S. Application Data
(63) Continuation of application No. 12/694,835, filed on Jan. 27, 2010.

(51) Int. Cl. G06F 1/16

(52) U.S. Cl. CPC G06F 1/1616

(57) ABSTRACT

A clamshell device with a dual accelerometer detector includes a first keyboard portion including a first accelerometer, a second display portion including a second accelerometer, and a hinge for coupling the first portion to the second portion. Circuitry coupled to the first and second accelerometers provides an output signal in response to the position of the first and second portions of the clamshell device. The output signal is provided to indicate a shutdown or standby mode, tablet operation mode, a partially shut or power savings mode, a normal operating mode, or an unsafe operating mode.

### CROSS-REFERENCE TO RELATED APPLICATION

This application is a continuation of U.S. patent application Ser. No. 12/694,835 filed Jan. 27, 2010, the disclosure of which is incorporated by reference.

### TECHNICAL FIELD

The present invention is related to clamshell devices and, more particularly, to a dual accelerometer detector for a clamshell device.

### BACKGROUND

Today's mobile devices that have clamshell designs use a Hall sensor/magnet combination or switches to determine when the lid/display is closed. Examples of such mobile devices known in the art are cell phones, notebook computers, netbooks, and tablet personal computers, among many other such devices.

The “open/close” sensors contained in these devices are used to determine the state the device is in and impacts the operational mode of the device. For example, in notebook computers, when the device is closed, the LCD panel backlight is typically shut off. Closing the device can also cause a sleep or hibernation mode to be activated.

Magnetometers (electronic compass) are now being added into these mobile clamshell devices to assist in various new navigation applications. Removal of the existing Hall sensor/magnet is desirable because the magnet can cause an offset in the magnetometer reading, called a “hard iron” offset. Removal of simple switches is also desirable due to single point failure, wear, and reliability issues.

What is desired, therefore, is elimination of existing prior art closure detection mechanisms, while at the same time maintaining the ability to determine the relative positions of the keyboard and display portions in a mobile device in order to manage various operating modes thereof, including closure detection.

### SUMMARY

In an embodiment, a clamshell device having a dual accelerometer detector includes a first portion including a first accelerometer, a second portion including a second accelerometer, a hinge for coupling the first portion to the second portion, and circuitry coupled to the first and second accelerometers for providing an output signal in response to the position of the first and second portions of the clamshell device. The first portion of the clamshell device typically includes a keyboard, wherein the first accelerometer is located in or coupled to a motherboard of the keyboard. The second portion of the clamshell device typically includes a display, wherein the second accelerometer is located in a camera module or a circuit board of the display. The physical orientation (X/Y/Z axes) of the first accelerometer in relation to the second accelerometer (X/Y/Z axes) is known. The output signal is provided to indicate a shutdown or standby mode, tablet operation mode, a partially shut or power savings mode, a normal operating mode, or an unsafe operating mode.

In an embodiment, a system comprises: a portable computing device having a clam shell configuration including a keyboard portion and a display portion, wherein the display portion is connected to the keyboard portion by a hinge; a first three-axis accelerometer circuit mounted to the keyboard portion; a second three-axis accelerometer circuit mounted to the display portion; the three-axes comprising an X-axis, a Y-axis and a Z-axis; and a processing circuit coupled to receive three-axis accelerometer data from the first and second three-axis accelerometer circuits and configured to process the three-axis accelerometer data to determine, for each of the keyboard portion and the display portion, a first tilt angle of the X-axis relative to horizontal, a second tilt angle of the Y-axis relative to horizontal and a third tilt angle of the Z-axis relative to horizontal, and further determine from the first, second and third tilt angles of each of the keyboard portion and the display portion a relative orientation of the keyboard portion to the display portion with respect to the hinge.

### BRIEF DESCRIPTION OF THE DRAWINGS

The accompanying drawings, which are incorporated in and constitute a part of this specification, illustrate embodiments of the invention and together with the description, serve to explain the principles of the invention. In the figures:

FIG. 1 illustrates the locations of the first and second accelerometers placed in a clamshell device such as a notebook computer;

FIG. 2 further illustrates the locations of the first and second accelerometers placed in a notebook computer;

FIG. 3 includes first and second block diagrams of the system level circuitry for providing the detection function;

FIG. 4 shows the analog output of an accelerometer versus the tilt angle thereof;

FIG. 5 shows the digital output of an accelerometer versus the tilt angle thereof;

FIG. 6 illustrates the tilt angle calculation using three axes;

FIG. 7 illustrates the relative position of two accelerometers in a clamshell device in first and second examples;

FIG. 8 illustrates the relative position of two accelerometers in a clamshell device in shutdown or standby mode;

FIG. 9 illustrates the relative position of two accelerometers in a clamshell device in a partially shut power savings mode;

FIG. 10 illustrates the relative position of two accelerometers in a clamshell device in a normal operating mode;

FIG. 11 illustrates the relative position of two accelerometers in a clamshell device in a tablet operating mode; and

FIG. 12 illustrates the relative position of two accelerometers in a clamshell device in an unsafe operating mode.

### DETAILED DESCRIPTION

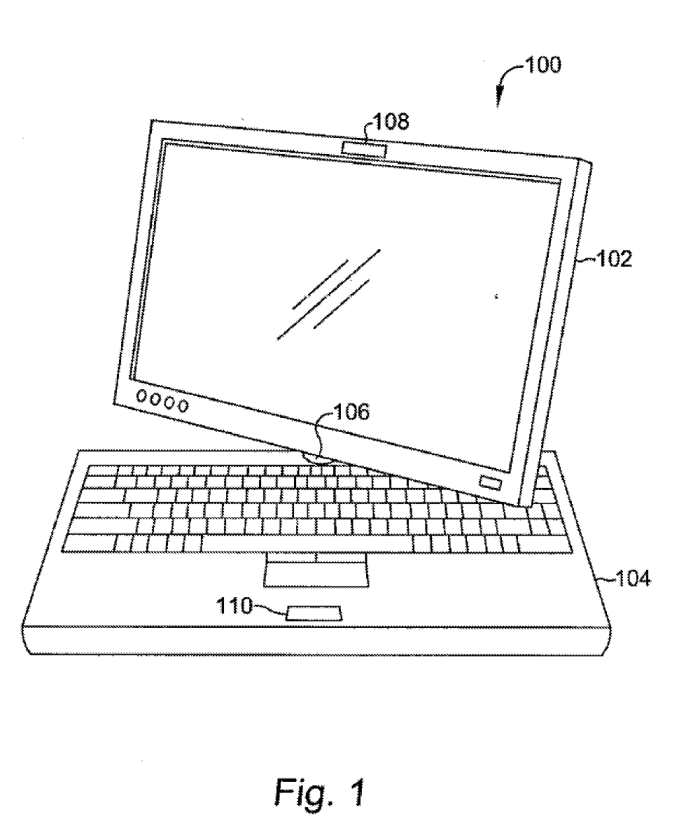

Referring now to FIG. 1, a clamshell device, in this case a personal computer, is shown having a first display portion 102 and a second keyboard portion 104, joined by a swivel hinge 106, as is known in the art. To accomplish the detection function, a first accelerometer 108 is located in a fixed, known orientation in the display portion 102, such as embedded in the camera module. The second accelerometer 110 is placed in a fixed, known orientation on the second keyboard portion 104 located on, or operatively in communication with, the motherboard of the computer.

The first and second accelerometers should be three axis capable accelerometers with either an analog or digital output.

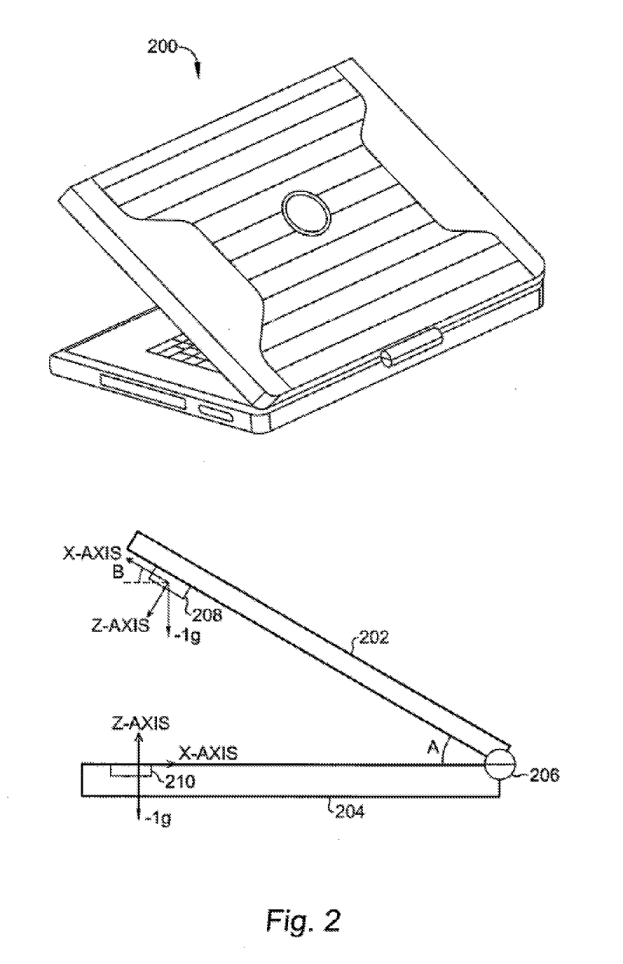

Referring now to FIG. 2, the personal computer 200 is shown in a position where neither the keyboard can be accessed nor can the display be properly viewed. In this example, the keyboard 204 is horizontal, and perpendicular with the Z-axis of accelerometer 210. This implies that the keyboard 204 is at rest on a flat surface. Angle A of the display 202 is inclined approximately 45 degrees. The Z-axis of accelerometer 208 is perpendicular to the display 202, and can provide the gravitational acceleration information associated with inclination tilt angle B. Knowing the fixed position and orientation of accelerometers 208 and 210, and the relative tilt angle with respect to horizontal of each, the relative position of angle A can be calculated. The personal computer 200 is shown in schematic form in which the computer includes the display 202 having the first accelerometer 208, and the keyboard 204 having the second accelerometer 210, joined by hinge 206. Using the method disclosed herein, when a relative angle of a predetermined number (for example, 10 degrees) is reached where neither the keyboard can be used nor the display seen, the backlight can be shut down, or a power savings mode can be entered.

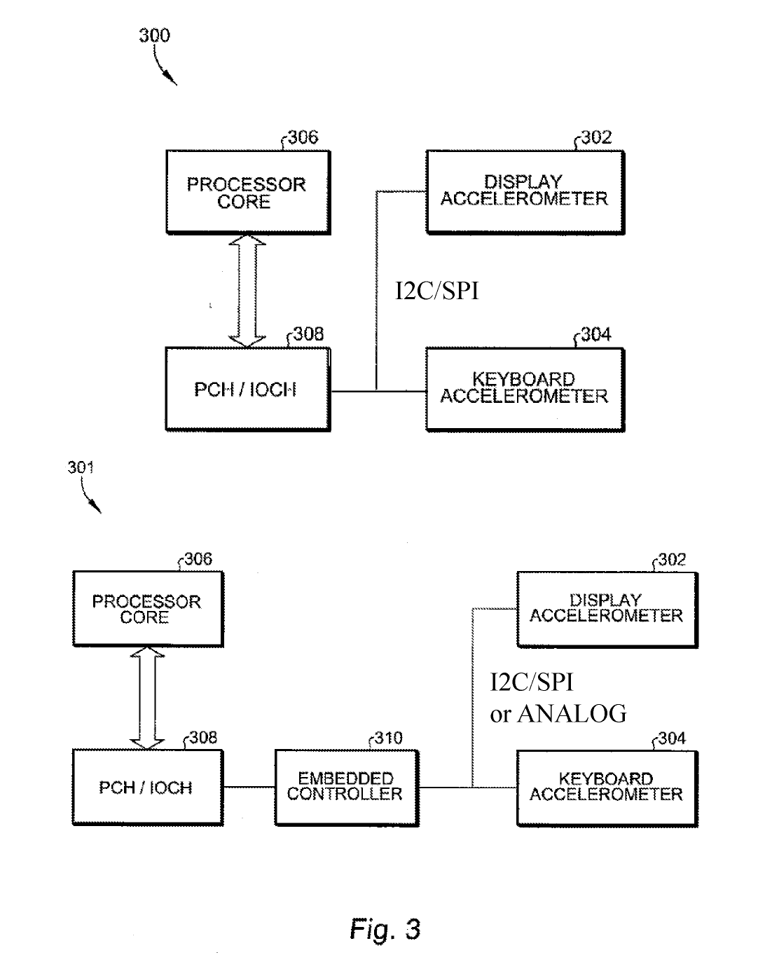

Referring now to FIG. 3, first and second block diagrams 300 and 302 are shown for the electronic processing circuitry used to process the information from the first and second accelerometers. The solution shown in FIG. 3 is a system level solution. In the case of a notebook computer, the processing implementation can be accomplished by connection of the display accelerometer 302 and the keyboard accelerometer 304 through an I2C or SPI bus to a Platform Controller Hub (PCH) or I/O Controller Hub (IOCH) 308 that is resident in the notebook directly. The Hub 308 is in communication with the resident computer processor core 306. Alternatively, an analog or digital display accelerometer 302 and an analog or digital keyboard accelerometer 304 can be coupled to an embedded controller 310 (typically the keyboard controller) through an I2C, SPI, or analog bus. The embedded controller then communicates with the PCH/IOCH 308, which is in communication with the resident computer processor core 306. Software drivers running on the resident computer processor core 306 are used to calculate the absolute angles of the display and keyboard and determine the relative angle to each other. Based on the relative calculated angles of the keyboard and display with respect to horizontal, the Operating System software running on the resident computer processor core 306 can adjust the system functional state accordingly. The implementation for other clamshell style devices such as a cell phone would be similar to that shown in FIG. 3.

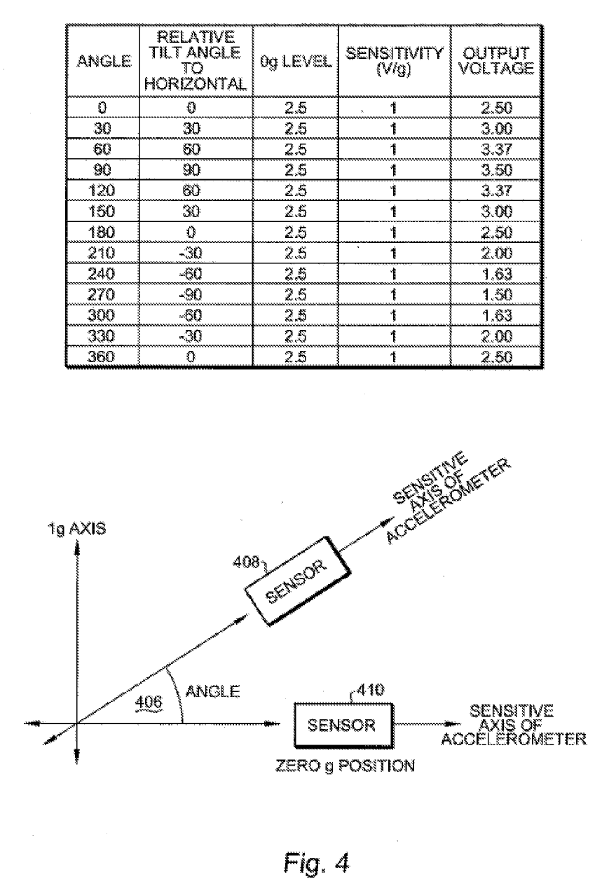

Referring now to FIG. 4, the output of a single axis of a typical three axis analog accelerometer is shown. In this case, let us assume the X axis output. There are two accelerometers shown in FIG. 4. Accelerometer 410 is associated with a resting keyboard of a personal computer, for example. The analog voltage output of accelerometer 410 is about 2.5 volts for a typical five volt supply voltage when the X axis is perfectly horizontal. This is known as the zero g level. As shown in FIG. 4, accelerometer 410 is in the “zero g” position, since the force of gravity is orthogonal to the sensitive axis of the accelerometer. There is no force of gravity in the sensitive axis of accelerometer 410. The output of sensor 408, however, is calculated as given by the equation below:

Output voltage=Zero g level+Sensitivity*sin (angle)

For a typical accelerometer, the sensitivity is about one volt per “g” unit of gravity. Thus, the output voltage can be seen in the table given in FIG. 4, wherein an angle of zero degrees results in the same “zero g” sensor position and results in an output voltage of about 2.5 volts. An angle of 30 degrees with a sensitivity of 1V/g results in an output voltage of about 3.0 volts. An angle of 60 degrees with the same sensitivity results in an output voltage of about 3.37 volts. The entire 360 degree output response is given in the table of FIG. 4 in 30 degree increments. The output voltage is used to calculate the absolute positions of both the keyboard and the display, and then the relative position therebetween. This relative position calculation is used to control various operating modes of the clamshell device, which are listed in detail below.

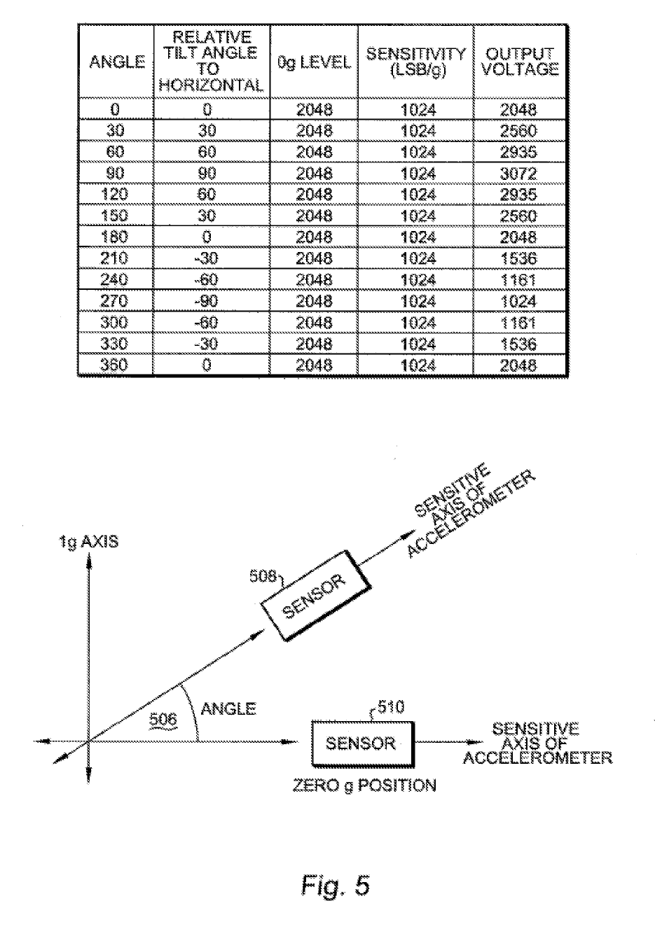

Referring now to FIG. 5, the output of a single axis of a typical three axis digital accelerometer is shown. In this case also, let us assume the X axis output. There are two accelerometers shown in FIG. 5. Accelerometer 510 is associated with a resting keyboard of a personal computer, for example. The digital output stored in an internal register of accelerometer 510 is 2048 counts when the X axis is perfectly horizontal. This is known as the zero g level. As shown in FIG. 5, accelerometer 510 is in the “zero g” position, since the force of gravity is orthogonal to the sensitive axis of the accelerometer. There is no force of gravity in the sensitive axis of accelerometer 510. The output value stored in the internal register of sensor 508, however, is calculated as given by the same equation below:

Output value=Zero g level+Sensitivity*sin (angle)

For a typical accelerometer, the sensitivity is about 1024 counts per “g” unit of gravity. Thus, the digital output can be seen in the table given in FIG. 5, wherein an angle of zero degrees results in the same “zero g” sensor position and results in an output value of 2048 counts. An angle of 30 degrees with a sensitivity of 1024 bits/g results in an output value of 2560 counts. An angle of 60 degrees with the same sensitivity results in an output value of 2935 counts. The entire 360 degree output response is given in the table of FIG. 5 in 30 degree increments. The digital output value is used to calculate the absolute positions of both the keyboard and the display, and then the relative position therebetween. This relative position calculation is used to control various operating modes of the clamshell device, which are listed in detail below.

It can be seen in tables of FIG. 4 and FIG. 5 that the output value is the same for 60 degrees as it is for 120 degrees due to the nature of the sine function. As such, it is impossible to determine the relative angle of the display and keyboard using a single axis. Using a three axis device, we can calculate the relative tilt angles for the X, Y and Z axis. With this data, the position of the accelerometer with respect to horizontal can be determined.

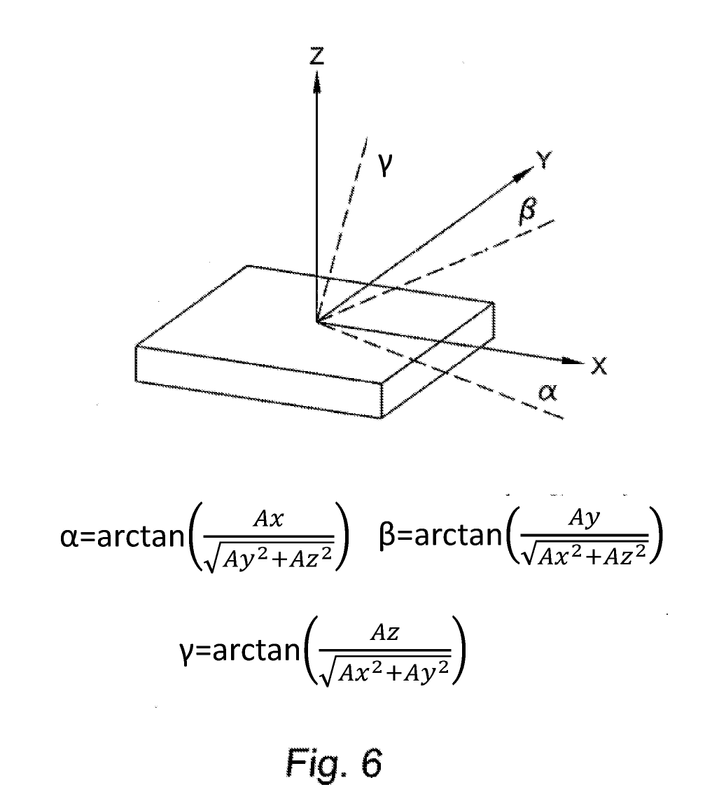

Referring now to FIG. 6, the tilt angle calculation using three axes is shown. The formulas for α, β and γ are given in FIG. 6, wherein Alpha is equal to the tilt angle of the X-axis with respect to horizontal. Beta is equal to the tilt angle of the Y-axis, and Gamma is the tilt angle of the Z-axis with respect to horizontal. Ax, Ay, and Az are the accelerations measured along the X, Y, and Z axes, respectively, wherein:

Acceleration=(Measured value−“Zero g” level)/Sensitivity

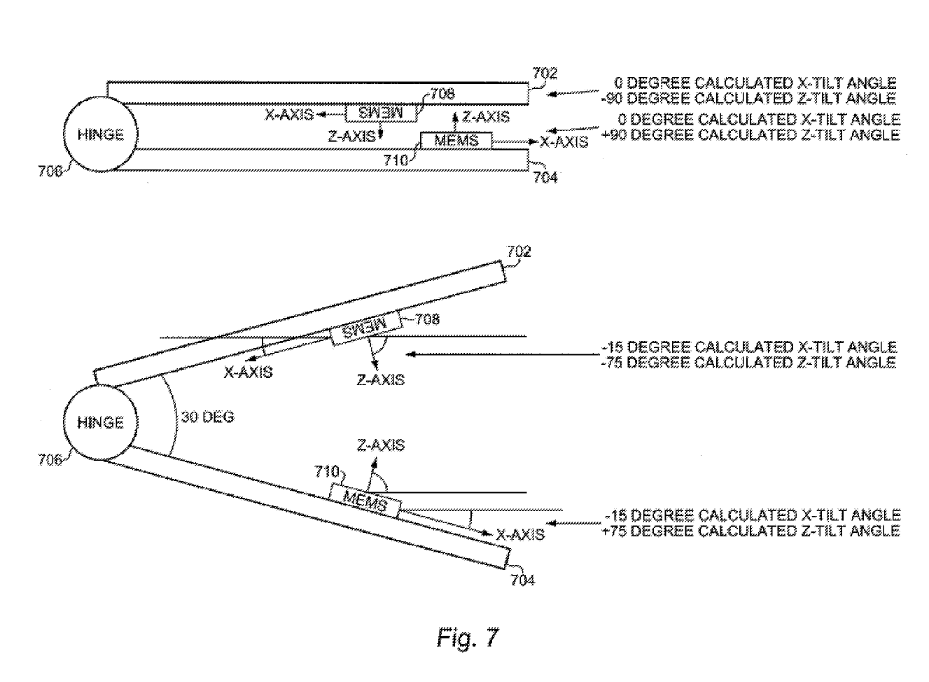

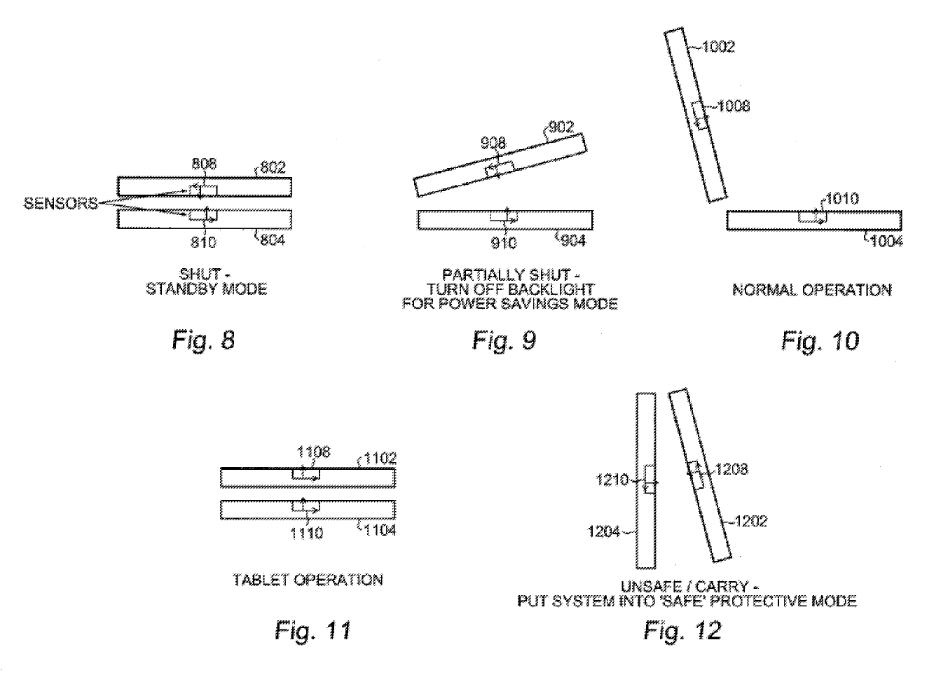

Referring now to FIG. 7, further analysis of the position between the keyboard and the display of a clamshell device is given. A clamshell device in, for example, a closed mode of operation is shown in the upper part of FIG. 7, wherein a first portion 702 with a first accelerometer 708, and a second portion 704 with a second accelerometer 710, are coupled together with a hinge 706. A zero tilt angle for the X-axis is measured for both accelerometers for the device in this position. A −90 degree Z-axis tilt angle is measured by first accelerometer 708, and a +90 degree Z-axis tilt angle is measured by the second accelerometer 710. Knowing the fixed locations and orientations of these accelerometers in the system, it can be determined that the clamshell device is closed. A clamshell device in, for example, a partially open mode of operation is shown in the lower part of FIG. 7, wherein a first portion 702 with a first accelerometer 708, and a second portion 704 with a second accelerometer 710, are coupled together with a hinge 706. A −15 degree X-axis tilt angle is calculated for both accelerometers for the device in this position, along with a −75 degree Z-axis tilt angle for accelerometer 708, and a +75 degree Z-axis tilt angle for accelerometer 710. Using this information it can be determined that the relative position of the display to the keyboard is 30 degrees. How the tilt angle is translated into controlling various operating modes is explained below with respect to FIGS. 8-12.

Referring now to FIG. 8, a shutdown or standby mode is shown for a clamshell device having a first portion 802 with an accelerometer 808 and a second portion 804 with an accelerometer 810. The algorithm for the shutdown or standby mode is as follows:

IF
The X-Axis of 808 is equal to the X-Axis of 810
AND
The Z-Axis of 808 is equal and opposite sign of Z-Axis of 810
AND
The X-Axis of 808 is +/−10 degrees
THEN
The system is ‘flat’ and can be placed into a sleep or standby mode.
ELSE

The device is tilted greater than 10 degrees and should be put into a ‘safe’ power down mode for carrying.

Referring now to FIG. 9, a partial shutdown or power saving mode is shown for a clamshell device having a first portion 902 with an accelerometer 908 and a second portion 904 with an accelerometer 910. The algorithm for the partial shutdown mode is as follows:

IF
The X-Axis of 910 is +/−10 degrees
AND
The Z-Axis of 910 is +90 degrees +/−10 degrees
THEN
The keyboard is ‘flat’ and can be used.
IF
The X-Axis of 908 is −20 degrees to −60 degrees (for example)
AND
The Z-Axis of 908 is negative
THEN

The display is tilted toward the keyboard and can not be accurately viewed. The system can be placed in a standby/sleep state OR the LCD backlight can be turned off to conserve power while keeping the rest of the system in a full-on state.

Referring now to FIG. 10, a normal operating mode is shown for a clamshell device having a first portion 1002 with an accelerometer 1008 and a second portion 1004 with an accelerometer 1010. The algorithm for the normal operating mode is as follows:

IF
The X-Axis of 1010 is +/−10 degrees
AND
The Z-Axis of 1010 is +90 degrees +/−10 degrees
THEN
The keyboard is ‘flat’ and can be used.
IF
The X-Axis of 1008 is −60 degrees to −90 degrees (for example)
AND
The Z-Axis of 1008 is either positive or negative
THEN

The Display is rotated open from 60 degrees up to 120 degrees and the system can be used in a full and normal manner as shown in FIG. 10.

Referring now to FIG. 11, a tablet operating mode is shown for a clamshell device having a first portion 1102 with an accelerometer 1108 and a second portion 1104 with an accelerometer 1110. The algorithm for the tablet operating mode is as follows:

IF
The X-Axis of 1108 is equal to the X-Axis of 1110
AND
The Z-Axis of 1108 is equal to the Z-Axis of 1110
THEN

The system is in ‘tablet’ mode with the display rotated ‘up’, and the device can be used in Tablet mode.

Portrait and Landscape detection can be used for the tablet by reading the X, Y and Z-axis values of 1108. The largest negative value will determine the ‘down’ side of the device, and the display image can be rotated accordingly.

Referring now to FIG. 12, an unsafe carrying mode is shown for a clamshell device having a first portion 1202 with an accelerometer 1208 and a second portion 1204 with an accelerometer 1210. The algorithm for the unsafe carrying mode is as follows:

IF
The X-Axis of 1208 greater than +/−10 degrees
THEN

The system keyboard is not flat, and the device can be put into a ‘safe’ carrying mode—with Hard Disk Drive retracted and powered down.

The present invention is not limited to any particular clamshell device, or to the display/keyboard embodiment shown herein. Other types of clamshell device would also take advantage of the principles of the present invention.

Although an embodiment of the present invention has been described for purposes of illustration, it should be understood that various changes, modification and substitutions may be incorporated in the embodiment without departing from the spirit of the invention that is defined in the claims, which follow.

1. A system, comprising:
a portable computing device having a clam shell configuration including a keyboard portion and a display portion, wherein the display portion is connected to the keyboard portion by a hinge;
a first three-axis accelerometer circuit mounted to the keyboard portion;
a second three-axis accelerometer circuit mounted to the display portion;
the three-axes comprising an X-axis, a Y-axis and a Z-axis; and
a processing circuit coupled to receive three-axis accelerometer data from the first and second three-axis accelerometer circuits and configured to process the three-axis accelerometer data to determine, for each of the keyboard portion and the display portion, a first tilt angle of the X-axis relative to horizontal, a second tilt angle of the Y-axis relative to horizontal and a third tilt angle of the Z-axis relative to horizontal, and further determine from the first, second and third tilt angles of each of the keyboard portion and the display portion a relative orientation of the keyboard portion to the display portion with respect to the hinge.

2. The system of claim 1, wherein the processing circuit further processes the relative orientation to control shut down of the portable computing device.

3. The system of claim 1, wherein the processing circuit further processes the relative orientation to control entry of the portable computing device into standby mode of operation.

4. The system of claim 1, wherein the processing circuit further processes the relative orientation to detect that the portable computing device is being carried.

5. The system of claim 1, wherein the processing circuit further processes the relative orientation to determine that the display cannot be viewed.

6. The system of claim 1, wherein the processing circuit further processes the relative orientation to determine that the keyboard cannot be actuated.

7. The system of claim 1, wherein the processing circuit further processes the relative orientation to determine that the display portion is in a tablet configuration relative the keyboard portion.

8. The system of claim 7, wherein the processing circuit further processes the relative orientation to control operation of the display portion in table configuration to present in a landscape mode.

9. The system of claim 7, wherein the processing circuit further processes the relative orientation to control operation of the display portion in tablet configuration to present in a portrait mode.

10. The system of claim 1, wherein the portable computing system includes a hard disk drive, and wherein the processing circuit further processes the relative orientation to control retraction of the hard disk drive.
